(19) United States
(12) Patent Application Publication
(10) Pub. No.: US 2009/0166440 A1
(43) Pub. Date: Jul. 2, 2009

(54) Method for Representing Numerical Data in a Barcode and Related Electronic Device

(76) Inventor: Chia-Chieh Liu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/330,524

(22) Filed: Dec. 9, 2008

(30) Foreign Application Priority Data
Dec. 27, 2007 (TW) 096150639

(51) Int. Cl. G06K 19/06

(52) U.S. Cl. 235/494

(57) ABSTRACT

A method for representing numerical data in a barcode includes corresponding a plurality of gray level values, including a gray level value of maximum reflection rate, a gray level value of minimum reflection rate, and at least one gray level value different from the gray level value of maximum reflection rate and the gray level value of minimum reflection rate, to a plurality of numbers, selecting a gray level value corresponding to the numerical data from the plurality of gray level values according to a value of the numerical data, and displaying the gray level value corresponding to the numerical data by a component of the barcode for representing the numerical data.

### BACKGROUND OF THE INVENTION

1. Field of the Invention

The present invention relates to a method and related electronic device for representing numerical data in a barcode, and more particularly, to a method and related electronic device for enhancing quantity of data stored in the barcode.

2. Description of the Prior Art

A barcode is an identification pattern arranged by black bars with various widths and blanks according to certain code rules for representing specific information. The barcode can indicate information of goods such as producing countries, manufacturers, trade names, dates of production, book classification numbers, beginning and ending locations of mails, categories, dates, etc., and thus is widely applied to fields like logistics, library management, post and telecommunications management, banking systems and so on.

The common barcode can be divided into two categories: one-dimensional barcode and two-dimensional barcode. The one dimensional bar code is a parallel line pattern formed by black and white bars, which stores data through the widths of the black and white bars. On the basis of the one-dimensional barcode, the two-dimensional barcode is expanded to another dimension for forming a readable barcode that stores data with the lengths and widths of the bars. Therefore, capacity (i.e. quantity of stored data) and complexity of the two-dimensional barcode are greater than that of the one-dimensional barcode.

However, either the one-dimensional barcode or the two-dimensional barcode represents specific data by two kinds of symbols with different gray values (such as black and white), and thus information indicated by a component of the barcode (i.e. a bit) is only 0 or 1. In this case, with widespread use of the barcodes, the capacity of the conventional barcodes seems to be insufficient gradually, so that the industry is devoted to development of a barcode that can store more data continuously.

### SUMMARY OF THE INVENTION

It is therefore a primary objective of the present invention to provide a method and related electronic device for representing numerical data in a barcode.

A method for representing numerical data in a barcode comprising mapping a plurality of gray level values is disclosed in the present invention. The method comprises a gray level value of maximum reflection rate, a gray level value of minimum reflection rate and at least one gray level value different from the gray level value of maximum reflection rate and the gray level value of minimum reflection rate to a plurality of numbers, selecting a gray level value corresponding to the numerical data from the plurality of gray level values according to a value of the numerical data, and displaying the gray level value corresponding to the numerical data by a component of the barcode for representing the numerical data.

An electronic device for representing numerical data through a barcode is further disclosed in the present invention. The electronic device comprises a mapping unit for mapping a plurality of gray level values comprising a gray level value of maximum reflection rate, a gray level value of minimum reflection rate and at least one gray level value different from the gray level value of maximum reflection rate and the gray level value of minimum reflection rate to a plurality of numbers, a reception unit for receiving the numerical data, a selection unit, coupled to the mapping unit and the reception unit, for selecting a gray level value corresponding to the numerical data from the plurality of gray level values according to a value of the numerical data received by the reception unit, and an output unit, coupled to the selection unit, for outputting a component of the barcode to display the gray level value corresponding to the numerical data for representing the numerical data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a process according to an embodiment of the present invention.

FIG. 2 is a schematic diagram of displaying a data according to the process in FIG. 1.

FIG. 3 is a schematic diagram of adding an error correction code to the data in FIG. 2.

FIG. 4 is a schematic diagram of an electronic device according to an embodiment of the present invention.

### DETAILED DESCRIPTION

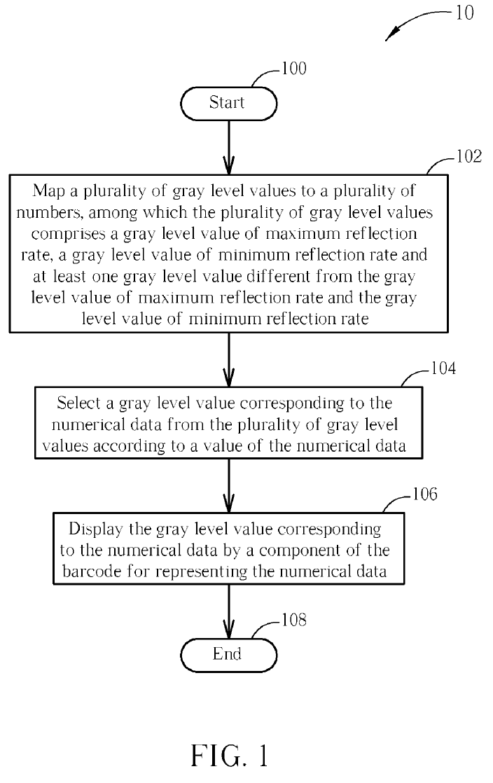

Please refer to FIG. 1. FIG. 1 is a schematic diagram of a process 10 according to an embodiment of the present invention. The process 10 is utilized for representing numerical data in a barcode, and includes the following steps:

Step 100: Start.

Step 102: Map a plurality of gray level values to a plurality of numbers, among which the plurality of gray level values comprises a gray level value of maximum reflection rate, a gray level value of minimum reflection rate and at least one gray level value different from the gray level value of maximum reflection rate and the gray level value of minimum reflection rate.

Step 104: Select a gray level value corresponding to the numerical data from the plurality of gray level values according to a value of the numerical data.

Step 106: Display the gray level value corresponding to the numerical data by a component of the barcode for representing the numerical data.

Step 108: End.

According to the process 10, not only the gray level value of maximum reflection rate and the gray level value of minimum reflection rate can be utilized for representing the numerical data in the barcode of the present invention, but the gray level values different from the gray level value of maximum reflection rate and the gray level value of minimum reflection rate can also be utilized for representing other numerical data. Preferably, the gray level value of maximum reflection rate is corresponding to a white color, and the gray level value of minimum reflection rate is corresponding to a black color. In other words, other than the black color and the white color, the present invention can utilize colors different from the black color and the white color, such as gray colors, to represent other numerical data. In this case, capacity (i.e. quantity of stored data) of a barcode can be enhanced by the present invention. Please note that, the present invention can be applied to one-dimensional barcodes and two-dimensional barcodes, and is not restricted herein.

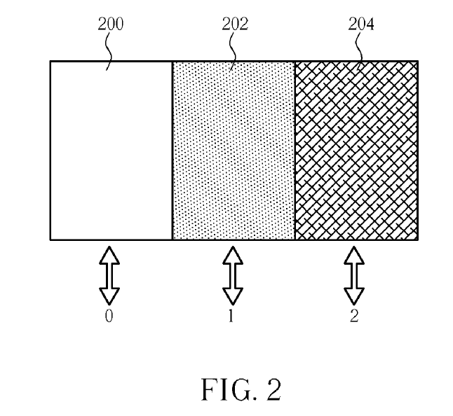

For example, if a component of the barcode can display three gray levels: white, gray and black colors, the present invention can map the white color to 0, the gray color to 1 and the black color to 2. In this case, the colors corresponding to data [0 1 2] can be seen in FIG. 2, which represents the gray color by a dot region and the black color by a mesh region. Thus, as shown in FIG. 2, components 200, 202 and 204 displaying the white, gray and black colors represent that corresponding values are 0, 1 and 2, respectively.

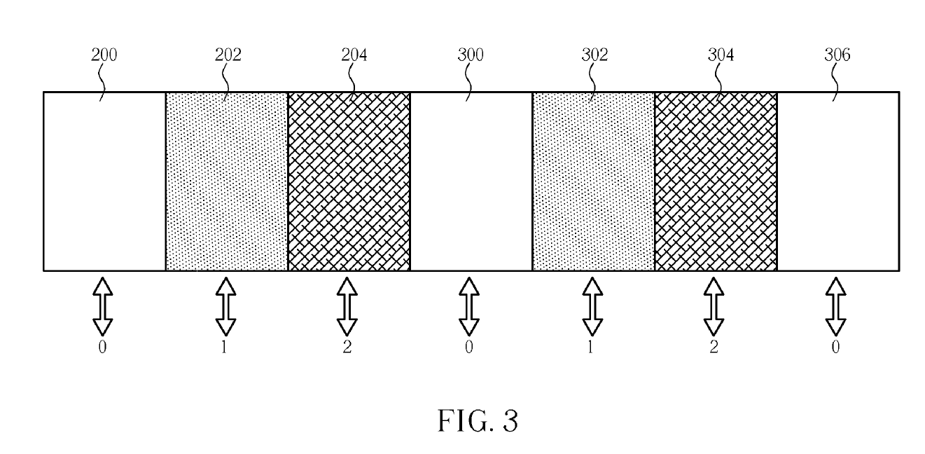

Except representing the numerical data by the white, gray and black colors, an error correction code can further be added to the original data in the present invention. In this case, the colors corresponding to the data [0 1 2] and the error correction code of the data are shown in FIG. 3. Referring to FIG. 3, components 300, 302 and 304 are duplicates of the components 200, 202 and 204, and a component 306 is a MOD operation result of the sum of the original data, i.e. (0+1+2)mod(3)=0, so that the data shown in FIG. 3 is then corresponding to [0 1 2 0 1 2 0].

After adding the error correction code, the present invention can correct one error or detect two errors of the data. For example, assuming the original data is [0 1 2 0 1 2 0] and an error changing the middle 0 to 1 occurs, the data then becomes [0 1 2 1 1 2 0]. When decoding the data, since the former three codes [0 1 2] and the later three codes [1 1 2] are different, error occurrence can be known accordingly. Next, since the sum of the former three codes [0 1 2] is 0, which conforms to the last code [0], but the sum of the later three codes [1 1 2] is 1, which does not conforms to the last code [0], the present invention can determine that the first 1 in the later three codes [1 1 2] is wrong, so that the error value of the data can be corrected. The above error correction code is merely an exemplary embodiment of the present invention, and those skilled in the art can certainly utilize other appropriate encoding methods according to practical demands.

Other than representing numerical data by the white and black colors, the present invention further utilizes other gray values for representing other numerical data. Please note that the number of the gray values is not restricted to any specific value, those skilled in the art can set the number of the gray values according to the data quantities that need to be represented when applying to different situations.

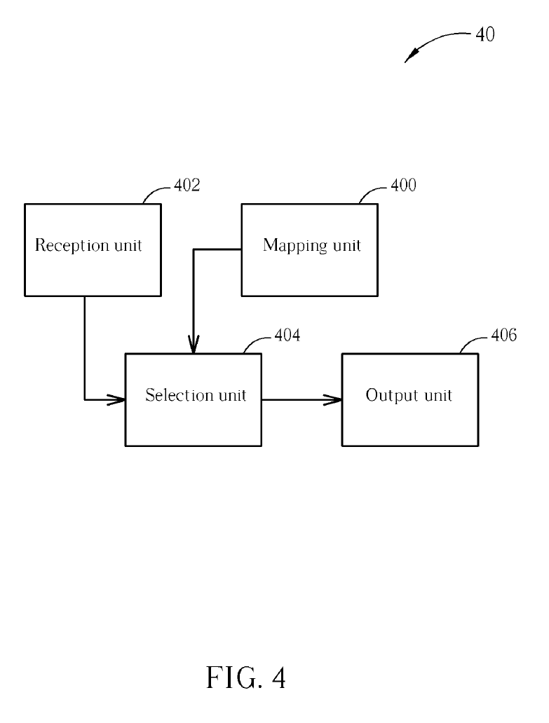

As for the realization of the process 1 0, please refer to FIG. 4. FIG. 4 is a schematic diagram of an electronic device 40 according to an embodiment of the present invention. The electronic device 40 is utilized for representing numerical data through a barcode, and includes a mapping unit 400, a reception unit 402, a selection unit 404 and an output unit 406. The mapping unit 400 is utilized for mapping a plurality of gray level values to a plurality of numbers, among which the plurality of gray level values comprises a gray level value of maximum reflection rate, a gray level value of minimum reflection rate and at least one gray level value different from the gray level value of maximum reflection rate and the gray level value of minimum reflection rate. The reception unit 402 is utilized for receiving the numerical data. The selection unit 404 is coupled to the mapping unit 400 and the reception unit 402, and is utilized for selecting a gray level value corresponding to the numerical data from the plurality of gray level values according to a value of the numerical data received by the reception unit 402. The output unit 406 is coupled to the selection unit 404, and is utilized for outputting a component of the barcode to display the gray level value corresponding to the numerical data for representing the numerical data. The electronic device 40 is utilized for realizing the process 10, and related operation is not narrated again herein.

As mentioned above, the present invention can utilize other gray values for representing numerical data except the black and white colors, so that capacity of a barcode can be enhanced.

Those skilled in the art will readily observe that numerous modifications and alterations of the device and method may be made while retaining the teachings of the invention.

What is claimed is:

1. A method for representing numerical data in a barcode comprising:
mapping a plurality of gray level values, comprising a gray level value of maximum reflection rate, a gray level value of minimum reflection rate and at least one gray level value different from the gray level value of maximum reflection rate and the gray level value of minimum reflection rate, to a plurality of numbers;
selecting a gray level value corresponding to the numerical data from the plurality of gray level values according to a value of the numerical data; and
displaying the gray level value corresponding to the numerical data by a component of the barcode for representing the numerical data.

2. The method of claim 1, wherein the barcode is a one-dimensional barcode.

3. The method of claim 1, wherein the barcode is a two-dimensional barcode.

4. The method of claim 1, wherein the gray level value of maximum reflection rate is corresponding to a white color.

5. The method of claim 1, wherein the gray level value of minimum reflection rate is corresponding to a black color.

6. An electronic device for representing numerical data through a barcode comprising:
a mapping unit for mapping a plurality of gray level values, comprising a gray level value of maximum reflection rate, a gray level value of minimum reflection rate and at least one gray level value different from the gray level value of maximum reflection rate and the gray level value of minimum reflection rate, to a plurality of numbers;
a reception unit for receiving the numerical data;
a selection unit, coupled to the mapping unit and the reception unit, for selecting a gray level value corresponding to the numerical data from the plurality of gray level values according to a value of the numerical data received by the reception unit; and
an output unit, coupled to the selection unit, for outputting a component of the barcode to display the gray level value corresponding to the numerical data for representing the numerical data.

7. The electronic device of claim 6, wherein the barcode is a one-dimensional barcode.

8. The electronic device of claim 6, wherein the barcode is a two-dimensional barcode.

9. The electronic device of claim 6, wherein the gray level value of maximum reflection rate is corresponding to a white color.

10. The electronic device of claim 6, the gray level value of minimum reflection rate is corresponding to a black color.
